(19) United States
(12) Patent Application Publication
(10) Pub. No.: US 2002/0055012 A1
(43) Pub. Date: May 9, 2002

(54) Optical data recording medium

(76) Inventors: Lih-Hsin Chou, Hsinchu (TW); Ying-Hwa Hwang, Kaohsiung (TW); Min-Hua Lin, Taichung (TW); Yao-Chang Wang, Chiai (TW); Lih-Hsiung Chan, Kaohsiung (TW)

Correspondence Address: Ladas & Parry, Suite 1200, 224 South Michigan Avenue, Chicago, IL, 60604, US

(21) Appl. No.: 09/902,340

(22) Filed: Jul. 10, 2001

(30) Foreign Application Priority Data
Nov. 4, 2000 (TW) 089123312

(51) Int. Cl. G11B 7/24; B32B 9/00

(52) U.S. Cl. 428/688

(57) ABSTRACT

An optical data recording medium includes a light transmittable plastic substrate, and a recording layer formed on the plastic substrate and containing a hydrogenated amorphous material that is selected from a group consisting of hydrogenated amorphous carbon, hydrogenated amorphous silicon carbide, hydrogenated amorphous boron carbide, hydrogenated amorphous boron nitride, hydrogenated amorphous silicon, and hydrogenated amorphous germanium.

### CROSS-REFERENCE TO RELATED APPLICATION

This application claims priority of Taiwan patent Application No.89123312, filed on Nov. 4, 2000.

### BACKGROUND OF THE INVENTION

1. Field of the Invention

This invention relates to an optical data recording medium, more particularly to an optical data recording medium having an optical data recording layer that contains a hydrogenated amorphous material.

2. Description of the Related Art

U.S. Pat. No. 5,252,370 discloses an optical data recording medium which is capable of reproduction according to CD standard and which includes a recording layer of silver oxide or iron nitride on a substrate that is made from a resin material. A dielectric layer of silicon oxide and a reflective layer of a metal are stacked on the recording layer. The recording layer decomposes and releases gas, and the substrate is softened and is formed with recesses that result from the formation of the gas when irradiated with a laser beam. The recesses in the substrate result in lowering of the reflectivity thereat, thereby providing the optical data recording medium with a reproduction capability according to the CD standard. However, the aforesaid optical data recording medium is disadvantageous in that it requires a dielectric layer for protection of the recording layer and for ensuring formation of the recesses in the substrate.

Gambino et al., “Solid State Comm., Vol. 34, P 15, 1980”, discloses an amorphous carbon film formed by plasma chemical vapor deposition techniques. The thus formed carbon film is hard and transparent, and has a random network of sp² and sp³ covalent bonded carbon with fractions depending on the process parameters employed in the plasma chemical vapor deposition.

Chou et al., “J. Appl. Phys. Vol. 74(7), Oct. 1, 1993”, discloses a hydrogenated amorphous carbon film formed by plasma assisted chemical vapor deposition techniques. The hydrogen content and the fractions of the sp² and sp³ covalent bonded carbon in the carbon film are significantly dependent on the process parameters employed in the plasma chemical vapor deposition.

### SUMMARY OF THE INVENTION

The object of the present invention is to provide an optical data recording medium that includes a recording layer of a hydrogenated amorphous material that is hard, transparent, and resistant to moisture and chemicals and that is capable of overcoming the aforementioned drawbacks.

According to the present invention, an optical data recording medium comprises: a light transmittable plastic substrate; and a recording layer formed on the plastic substrate and containing a hydrogenated amorphous material that is selected from a group consisting of hydrogenated amorphous carbon, hydrogenated amorphous silicon carbide, hydrogenated amorphous boron carbide, hydrogenated amorphous boron nitride, hydrogenated amorphous silicon, and hydrogenated amorphous germanium.

### BRIEF DESCRIPTION OF THE DRAWINGS

In drawings which illustrate an embodiment of the invention,

FIG. 1 is a cross-sectional view illustrating a preferred embodiment of an optical data recording medium of this invention, which includes a recording layer and a reflective layer on a plastic substrate;

FIG. 2 is a cross-sectional view illustrating the preferred embodiment of the optical data recording medium of this invention, which can optionally further include a layer of a low melting metal; and

FIG. 3 is a cross-sectional view illustrating the preferred embodiment of the optical data recording medium of this invention, which can optionally further include a layer of a dielectric material.

### DETAILED DESCRIPTION OF THE PREFERRED EMBODIMENT

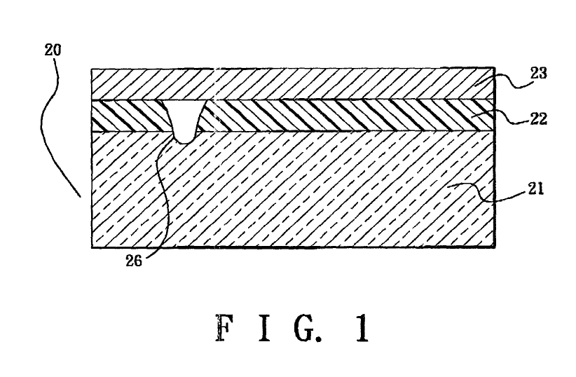

FIG. 1 illustrates a write-once type optical data recording medium that embodies this invention. The optical data recording medium includes a recording layer 22 and a reflective layer 23 on a light transmittable plastic substrate 21, and can be recorded or written by formation of pits or recesses 26 in the plastic substrate 21.

The recording layer 22 preferably has a thickness in a range of from about 30 nm to 2500 nm, and contains a hydrogenated amorphous material that is selected from a group consisting of hydrogenated amorphous carbon, hydrogenated amorphous silicon carbide, hydrogenated amorphous boron carbide, hydrogenated amorphous boron nitride, hydrogenated amorphous silicon, and hydrogenated amorphous germanium. Preferably, the hydrogenated amorphous material is hydrogenated amorphous carbon with sp² and sp³ covalent bonded carbon, contains 5 to 60 atomic percent hydrogen, and has a hardness greater than that of the plastic substrate 21.

Heat measurements of hydrogenated amorphous carbon via Modulated Differential Scanning Calorimetry (MDSC) show that the hydrogenated amorphous carbon decomposes and releases hydrogen at a temperature of about 350° C. Moreover, annealing (heat treatment) of the hydrogenated amorphous carbon shows that a significant change in the hydrogen content of the hydrogenated amorphous carbon occurs when annealing proceeds at a temperature greater than 300° C. For instance, the hydrogen content of the hydrogenated amorphous carbon changes from 32.78 atomic percent hydrogen to 31.88 atomic percent hydrogen after annealing at a temperature of 300° C. for 1 hour, and changes to 25.33 atomic percent hydrogen after annealing at a temperature of 375° C. for 1 hour.

The recording layer 22 can be formed via plasma assisted chemical vapor deposition techniques by decomposition of a hydrocarbon with a pressure of 20 to 400 milli-torrs and a substrate bias voltage in a range of from 250 to 550 volts.

The plastic substrate 21 is made from a resin material selected from a group consisting of acrylic resins, polycarbonate resins, epoxy resins, and polyolefin resins. Preferably, the recording layer 22 has a hardness greater than that of the plastic substrate 21.

The reflective layer 23 is made from a metal selected from a group consisting of gold, silver, aluminum, titanium, chromium, nickel, iron, copper, palladium, tantalum, and an alloy thereof.

Preferably, the hydrogenated amorphous material decomposes and releases hydrogen at a temperature greater than 300° C., whereas the plastic substrate is softened at a temperature in a range of from 80° C. to 300° C. so as to permit formation of recesses 26 in the plastic substrate 21 as a result of the hydrogen released by the hydrogenated amorphous material and so as to permit a sharp change in reflectivity at positions where the recesses 26 are formed. The recording of the optical data recording medium can be carried out by irradiating a laser beam through the substrate 21 into the recording layer 22 which absorbs energy from the laser beam so as to release hydrogen to form the recesses 26. In case of hydrogenated amorphous carbon, the laser beam employed for the formation of the recesses 26 preferably has an energy density in a range of from 100 to 200 mJ/cm².

Preferably, the thus formed optical data recording medium has a reflectivity greater than 40% in response to a wavelength of from 300 to 900 nm so as to meet the CD or DVD standard.

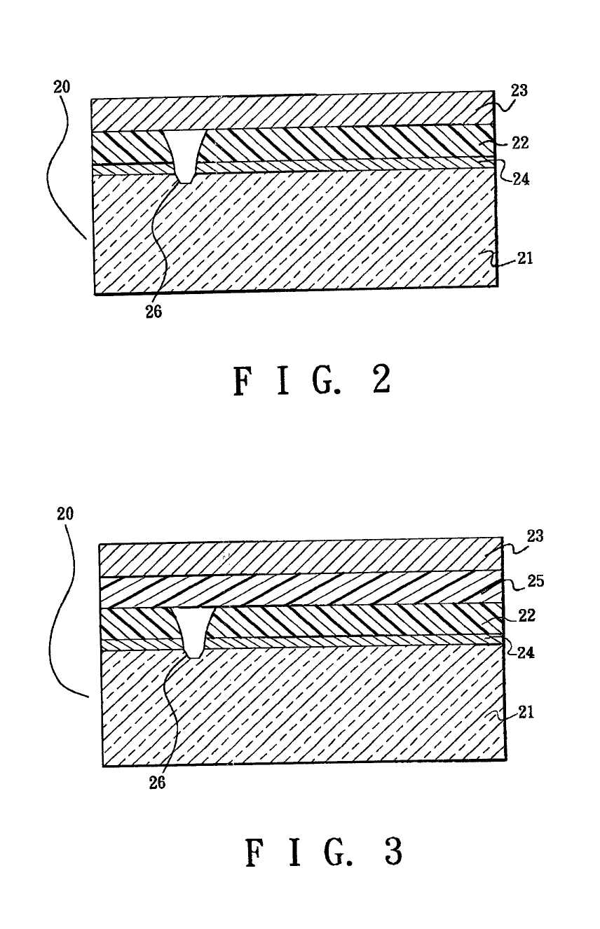

Referring to FIG. 2, the optical data recording medium of this invention can further include a metal layer 24 disposed between the recording layer 22 and the plastic substrate 21 so as to enhance recording sensitivity thereof. The metal layer 24 is preferably a low melting point metal selected from a group consisting of Sn, Zn, Pb, Bi, Tl, Te, Se, Al, Ga, Ge, Cd, and alloys thereof, and has a thickness in a range of from 5 to 300 angstroms.

Referring to FIG. 3, the optical data recording medium of this invention can further include a dielectric layer 25 disposed between the recording layer 22 and the reflective layer 23 for enhancing the recording sensitivity thereof and for adjusting the reflectivity thereof. The dielectric layer 25 can be made from a material selected from a group consisting of silicon oxide, zirconium oxide, titanium oxide, tantalum oxide, magnesium fluoride, aluminum fluoride, aluminum nitride, silicon nitride, SiON, AlON, zinc sulfide, and mixtures thereof.

### EXAMPLE 1

A recording layer of hydrogenated amorphous carbon with a thickness of about 100 nm was formed on a polycarbonate substrate via plasma assisted chemical vapor deposition techniques by decomposition of a hydrocarbon with a pressure of 20 to 400 milli-torrs and a substrate bias voltage of 400 volts. The thus formed recording layer contained 5 to 60 atomic percent hydrogen. The plastic substrate was held at a temperature of about room temperature during the formation of the recording layer. A reflective layer of aluminum with a thickness of about 50 nm was subsequently formed on the recording layer. The assembly of the substrate, the recording layer and the reflective layer was irradiated with a laser beam that has a pulse laser energy density in a range of from 105 to 172 mJ/cm² with a pulse width in the range from 50 to 300 nanoseconds and a wavelength of 660 nm. Contrast ratios in reflectivity of the assembly at the position where the recording layer was irradiated were measured for different pulse laser energy densities. The contrast ratio was calculated as follows:

Contrast ratio=(reflectivity before irradiation−reflectivity after irradiation)/reflectivity before irradiation.

With the pulse laser energy density increased from 143 mJ/cm² to 152 mJ/cm², the contrast ratio increased from 8% to 19%, which indicated that a significant amount of hydrogen was released from the recording layer and a recess was formed in the substrate. With the pulse laser energy density further increased to 172 mJ/cm², the contrast ratio increased to 38%, which indicated that a larger recess was formed in the substrate. The dimension of the thus formed recess, which resulted from a pulse laser energy density of 172 mJ/cm², was measured via Scanning Electron Microscopy (SEM) device and has a generally elliptic shape with a depth of about 250 nm, a top long diameter of 7 nm, a top short diameter of 3 nm, a bottom long diameter of 1.2 nm, and a bottom short diameter of 0.7 nm.

With the hydrogenated amorphous material as the recording layer 22, the drawbacks associated with the prior art can be eliminated. Moreover, the property of the recording layer thus constructed permits the optical data recording medium of this invention to meet the CD and DVD standards.

With the invention thus explained, it is apparent that various modifications can be made without departing from the spirit of the present invention. It is therefore intended that the invention be limited only as recited in the appended claims.

We claim:

1. An optical data recording medium, comprising:
a light transmittable plastic substrate; and
a recording layer formed on said plastic substrate and containing a hydrogenated amorphous material that is selected from a group consisting of hydrogenated amorphous carbon, hydrogenated amorphous silicon carbide, hydrogenated amorphous boron carbide, hydrogenated amorphous boron nitride, hydrogenated amorphous silicon, and hydrogenated amorphous germanium.

2. The optical data recording medium of claim 1, wherein said recording layer has a hardness greater than that of said plastic substrate.

3. The optical data recording medium of claim 1, wherein said hydrogenated amorphous material decomposes and releases hydrogen at a temperature greater than 300° C., whereas said plastic substrate is softened at a temperature in a range of from 80° C. to 300° C. so as to permit formation of recesses in said plastic substrate as a result of the hydrogen released by said hydrogenated amorphous material.

4. The optical data recording medium of claim 1, wherein said hydrogenated amorphous material contains 5 to 60 atomic percent hydrogen.

5. The optical data recording medium of claim 1, wherein said hydrogenated amorphous material is hydrogenated amorphous carbon.

6. The optical data recording medium of claim 1, wherein said recording layer has a thickness in a range of from about 30 nm to 2500 nm.

7. The optical data recording medium of claim 1, wherein said plastic substrate is made from a resin material selected from a group consisting of acrylic resins, polycarbonate resins, epoxy resins, and polyolefin resins.

8. The optical data recording medium of claim 1, wherein said recording layer is formed on said plastic substrate via plasma assisted chemical vapor deposition techniques by decomposition of a hydrocarbon with a pressure of 20 to 400 milli-torrs and a substrate bias voltage in a range of from 250 to 550 volts.

9. The optical data recording medium of claim 1, further comprising a reflective layer formed on said recording layer such that said optical data recording medium has a reflectivity greater than 40% in response to a wavelength of from 300 to 900 nm.

10. An optical data recording medium, comprising:
a light transmittable plastic substrate; and
a recording layer formed on said plastic substrate and made from hydrogenated amorphous carbon which contains 5 to 60 atomic percent hydrogen and which decomposes and releases hydrogen at a temperature greater than 300° C., said plastic substrate being softened at a temperature in a range of from 80° C. to 300° C. so as to permit formation of recesses in said plastic substrate as a result of the hydrogen released by said hydrogenated amorphous carbon.

11. The optical data recording medium of claim 10, further comprising a reflective layer formed on said recording layer such that said optical data recording medium has a reflectivity greater than 40% in response to a wavelength of from 300 to 900 nm.

12. The optical data recording medium of claim 10, wherein said plastic substrate is made from a resin material selected from a group consisting of acrylic resins, polycarbonate resins, epoxy resins, and polyolefin resins.

13. The optical data recording medium of claim 10, wherein said recording layer is formed on said plastic substrate via plasma assisted chemical vapor deposition techniques by decomposition of a hydrocarbon with a pressure of 20 to 400 milli-torrs and a substrate bias voltage in a range of from 250 to 550 volts.

14. The optical data recording medium of claim 13, wherein said plastic substrate is held at a temperature of about room temperature during the formation of said recording layer.
